(19) United States
(12) Patent Application Publication
(10) Pub. No.: US 2015/0350131 A1
(43) Pub. Date: Dec. 3, 2015

(54) METHOD AND DEVICE FOR CONTROLLING THE DISPLAY OF A GROUP OF CONTACTS

(71) Applicant: Orange, Paris (FR)

(72) Inventors: Cedric Floury, Perros Guirec (FR); Violaine Mercier, Pleumeur Bodou (FR)

(21) Appl. No.: 14/722,827

(22) Filed: May 27, 2015

(30) Foreign Application Priority Data
May 27, 2014 (FR) 1454786

(51) Int. Cl. H04L 12/58; H04L 29/08

(52) U.S. Cl. CPC H04L 51/046; H04L 67/10

(57) ABSTRACT

A method and a device are provided for controlling the display of a group of contacts associated with a terminal. The group of contacts is ordered according to a first predetermined criterion, and displayed according to this arrangement. Each contact is represented in a frame of predetermined size. When at least one contact of the group fulfills a second predetermined criterion, the display control method includes enlarging the frame in which the contact is displayed so that a user scrolling through the list of contacts can easily identify a contact fulfilling the second predetermined criterion.

### FIELD OF THE DISCLOSURE

The invention is located in the field of communication terminals.

### BACKGROUND OF THE DISCLOSURE

To initiate a communication from his/her terminal, a user can select the recipient identity of the communication from a contact saved in a phonebook associated with the terminal. In general, contacts are presented to the user in the form of an ordered list displayed on a screen of the terminal. For example, such a list can be sorted in alphabetical order by contact name.

Since the display surface of the terminal is in general of small size, the list of contacts cannot in general be displayed in full. To select a contact with whom a user desires to initiate a communication, that user must then scroll through the list of contacts by interacting on the terminal to modify the display and make the list of contacts scroll until the user identifies the contact with whom he/she wishes to initiate a communication.

When the user has a large number of contacts saved in the phonebook associated with his/her terminal, for example more than about 50 contacts, selecting a predetermined contact can then become tedious if the contact is not arranged at the start of the list.

Present-day terminals propose a mechanism for searching for a contact in the phonebook from the entry of a part of the name of the contact in a search field displayed to the user. This mechanism requires the user to have memorized the name in which the contact was saved, which is not always the case when the user does not communicate often with this contact or when the contact has been saved following the reception by the terminal of an information file for the contact. In the latter case, the user did not then have to enter the name of the contact in order to save the contact and therefore has less chance of remembering the contact.

Furthermore, the search mechanism requires a certain number of interactions by the user on the terminal in order to start the search.

The document US2008/0146190 A1 describes a method for displaying on the terminal of the user an ordered list of contacts, which list is sorted according to the frequency with which the user communicates with each contact. Thus, the contacts with whom the user communicates most often are arranged at the start of the list. Such a method updates the ordered list of contacts and provides a dynamic list in which the contacts can be arranged differently between each use of the terminal by the user. When the user wishes to communicate with a contact which is not arranged at the start of the list, it becomes more difficult to identify this contact since the arrangement of the list no longer follows a predetermined order according to which the user can easily find his/her way inside the list.

In the prior art, certain representations provide for displaying preferred contacts of the user on a separate interface of the list of contacts of the terminal. In order to select a contact, the user must first select an interface, thereby increasing the number of interactions of the user on the terminal in order to select a contact. Furthermore, if the user selects the interface for the preferred contacts and if the contact with whom the user wishes to communicate is not on this interface, the user must select another interface presenting the contacts of the terminal.

### SUMMARY

An exemplary embodiment of the present disclosure proposes a method for controlling the display of a group of contacts associated with a terminal. At least one piece of information relating to each contact of at least one subgroup of the group of contacts is displayed in a frame of predetermined size and according to a determined arrangement according to a first predetermined criterion. According to the display control method, when at least one contact of the subgroup fulfills a second predetermined criterion, the method comprises a step for enlarging the frame in which the piece of information relating to said at least one contact is displayed. Thus, the method an exemplary embodiment provides the user of a terminal with a display of contacts associated with the terminal according to a predetermined order and on which contacts are represented in various sizes on the screen of the terminal. Thus, the user retains an easy route through the list of contacts of his/her terminal since the contacts are displayed according to a predetermined order which the user knows. In the prior art, the contacts of the group of contacts are displayed in identically-sized frames. The method according to an exemplary embodiment modifies the display of at least one contact fulfilling the second predetermined criterion so as to display the determined contact in a larger frame.

The user can thus easily identify on the screen of the terminal the contacts which are displayed in a larger size than other contacts. For example, the contacts of the group which are displayed in a larger frame correspond to contacts with whom the user communicates most often or to contacts for whom the user has set a preference parameter.

The contacts associated with the terminal can correspond to the contacts saved in the phonebook of the terminal or to the contacts of a call log of the terminal, or to a list of contacts of a social network service, etc.

An exemplary embodiment applies to all modes of representation of a group of contacts of a terminal. For example, an exemplary embodiment applies to a mode of representation displaying the contacts of a list of contacts in the form of a sequence of frames comprising the name of the contact and placed one underneath the other according to said arrangement. Such a mode of representation is conventionally used in terminals for displaying contacts of a phonebook or call log.

According to another example, an exemplary embodiment also applies to a mode of representation displaying the contacts of a group of contacts in the form of a tiling of frames, each frame comprising for example the photo of the contact.

The various embodiments or features of implementation mentioned hereafter can be added independently or in combination with one another to the features of the method defined above.

According to a particular embodiment, the first predetermined criterion corresponds to an alphabetical order or to a chronological order according to a last communication established between the terminal and the contact considered during the arrangement step.

As a variant, the first predetermined criterion can be an order defined beforehand by the user.

According to another particular embodiment, the second predetermined criterion corresponds to the frequency with which the terminal and the contact considered during the arrangement step establish calls.

According to another particular embodiment, the enlarged frame is displayed in the same display window as the frames of predetermined size, on the display device of the terminal.

Advantageously, the method according to an exemplary embodiment provides the user with the list of his/her contacts on a single display window. The contacts are displayed within the same ordered list regardless of the size of the frame in which they are displayed. The user does not need to navigate between different windows according to whether or not the contact sought fulfills the second criterion.

According to another particular embodiment, when an item relating to a communication with a contact is also displayed in the frame of predetermined size in which the pieces of information of a contact are displayed, for the at least one contact fulfilling the second predetermined criterion, at least one additional item relating to said communication is displayed in said enlarged frame.

According to this particular embodiment, the display method provides for supplying to the user, for the contacts displayed in a larger frame, additional items relating to a communication established with these contacts. For example, an item relating to a communication corresponds to a part of a message exchanged with the contact, for example an SMS or MMS message or a message of an instant messaging session. In the prior art, when the contact is displayed in a frame of predetermined size, only the first line of the item relating to the communication, in this case the first line of the message, is displayed. According to this particular embodiment, at least a second line of the message can be displayed, or the whole message can be displayed. Thus, the user can read the information of the last message exchanged with the contact, without requiring additional interaction on the terminal.

An item relating to a communication can also correspond to information relating to the reception of a call from said contact or to the transmission of a call to said contact, such information being saved in the call log of the terminal. According to the particular embodiment described here, the additional item relating to the communication can correspond to a message or to a multimedia object which the contact has sent during the communication. The user thus has the additional item available without having to select the contact from the list in order to have access to the additional item.

According to another particular embodiment, when the frame in which a contact of the group of contacts is displayed comprises a predetermined color or a predetermined image, the method additionally comprises a step for modifying the color or the image of said frame according to the age of the last communication established with said contact.

According to this particular embodiment, the user more easily identifies contacts with whom he/she does not communicate often by virtue of the modification of the color of the image associated with the frame in which these contacts are displayed. The color associated with the frame can correspond to the background color of the frame, or to the outline of the frame, or to the color of the typeface of the pieces of information for the contact which are displayed in the frame. For example, the color of the frame can be modified such that the older the last communication established with the contact, the clearer or more transparent the color is.

According to another example, the frame comprises an image, for example a photo representing the contact. The image contained in the frame undergoes processing so that the colors of the image are degraded. The image is modified such that the older the last communication established with the contact, the clearer or more transparent the image is.

An exemplary embodiment relates also to a device for controlling the display of a group of contacts associated with a terminal. The display control device notably comprises a display device, and a display management module which is suitable for controlling the display of at least one piece of information relating to each contact of at least one subgroup of the group of contacts, in a frame of a predetermined size, and suitable for controlling the display, according to an arrangement of said group of contacts, determined according to a first predetermined criterion, of said frame of predetermined size on the display device. According to an exemplary embodiment, the display control device also comprises a processing module cooperating with the display management module. The processing module is suitable for verifying whether at least one contact of the subgroup fulfills a second predetermined criterion, and suitable for enlarging the size of the frame in which the at least one piece of information relating to said at least one contact is displayed.

According to a particular embodiment, the processing module is suitable for modifying the color used in the representation of a frame according to the age of the last communication established with said contact.

An exemplary embodiment relates also to a terminal comprising the display control device according to any one of the particular embodiments described above.

In a particular embodiment, the various steps of the method for controlling the display of a group of contacts are implemented by computer program instructions.

Consequently, another exemplary embodiment is a computer program on a data medium, this program being capable of being implemented respectively in a terminal or more generally in a computer, this program including instructions suitable for implementing the various steps of the method for controlling the display of a group of contacts which has just been described.

This program can use any programming language and be in the form of source code, object code or a code intermediate between source code and object code, such as in a partially compiled form or in any other desirable form.

Another exemplary embodiment is a data medium readable by a computer, and including instructions of a computer program as mentioned above.

The data medium can be any entity or device capable of storing the program. For example, the medium can include a means of storage such as a ROM, for example a CD-ROM or a microelectronic circuit ROM, or a magnetic or electronic recording means, for example a USB flash drive or a hard disk.

On the other hand, the data medium can be a transmittable medium such as an electrical or optical signal, which can be conveyed via an electrical or optical cable, via radio or via other means. The program can in particular be downloaded over an Internet type network.

Alternatively, the data medium can be an integrated circuit in which the program is incorporated, the circuit being adapted to execute or to be used in the execution of the method in question for controlling the display of a group of contacts.

The advantages of the computer program including instructions suitable for implementing the various steps of the method for controlling the display of a group of contacts are identical to those presented in connection with the method in question according to any one of the particular embodiments mentioned above.

### BRIEF DESCRIPTION OF THE DRAWINGS

Other advantages and features will become clearer upon reading the following description of a particular embodiment of the invention, which embodiment is given simply by way of illustrative and non-limiting example, and from the appended drawings in which:

FIG. 1 illustrates steps of the method for controlling the display of a group of contacts associated with a terminal according to a particular embodiment,

FIG. 2 schematically illustrates a device for controlling the display of a group of contacts associated with a terminal according to a particular embodiment,

FIG. 3A presents a representation of the display of a group of contacts associated with a terminal resulting from the display control method according to a particular embodiment,

FIG. 3B presents a representation of the display of a group of contacts associated with a terminal resulting from the display control method according to another particular embodiment,

FIG. 4 presents a representation of the display of a group of contacts associated with a terminal resulting from the display control method according to another particular embodiment.

### DETAILED DESCRIPTION OF ILLUSTRATIVE EMBODIMENTS

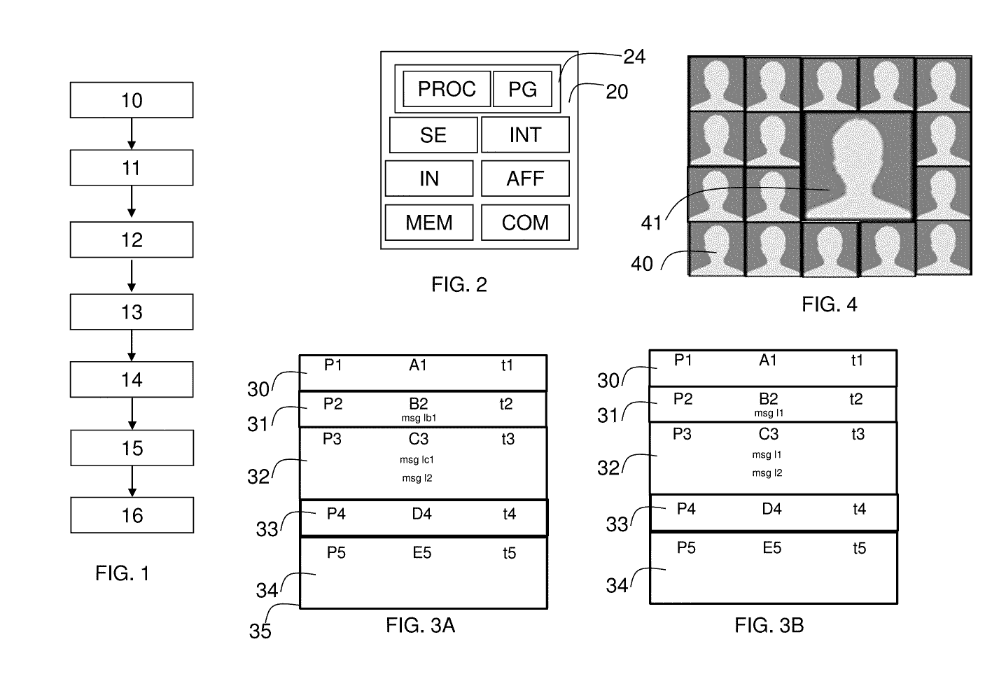

FIG. 1 illustrates steps of the method for controlling the display of a group of contacts associated with a terminal according to a particular embodiment.

The group of contacts associated with the terminal corresponds for example to the contacts saved in the phonebook of the terminal or to the contacts saved in a call log of the terminal, or to a list of contacts of a social network service, which list is saved on a server hosting the site of the social network.

The display control method comprises a step 10 for the arrangement of the group of contacts associated with the terminal according to a first predetermined criterion. When the group of contacts to be displayed corresponds to the contacts in the phonebook of the terminal, the first predetermined criterion corresponds to the alphabetical order. The contacts are then sorted in alphabetical order by the name associated with each contact.

According to another variant, when the group of contacts to be displayed corresponds to the contacts saved in a call log of the terminal, the first predetermined criterion corresponds to the reversed chronological order. In this variant, the contacts of the group are sorted by date and time of the last communication established between the contact and the terminal. According to this variant, the contact who has established the most recent communication with the terminal is the first contact in the ordered group.

During a step 11, for each contact of the group, a second predetermined criterion is verified.

Such a second predetermined criterion can correspond to the frequency of communications established between the contact in question and the terminal. The contact in question fulfills the second criterion when the frequency of communications between the contact in question and the terminal reaches a predetermined value. The frequency of communications between a contact and the terminal can be obtained by measuring the number of communications established between said contact and the terminal over a predetermined period, for example over a period of seven preceding days or a few preceding weeks, etc. In this variant, if the frequency of communications between the contact and the terminal is for example greater than 10 over the last seven days, the verification of the second predetermined criterion is positive. Otherwise, the verification of the second predetermined criterion is negative.

According to another variant, the second predetermined criterion is implemented by determining the contacts of the group of contacts that have established the greatest number of communications with the terminal over a predetermined period, for example the last seven days or the last month. According to this variant, the contacts of the group of contacts are arranged in descending order of the number of communications established with the terminal over the predetermined period. The contacts of the group of contacts fulfilling the second predetermined criterion are then the N first contacts according to this ordering. N can be a parameter fixed by the user of the terminal, or fixed by default to 5, 10 or any other value.

According to yet another variant, the second predetermined criterion corresponds to a preference parameter set beforehand by a user of the terminal for the contact in question. When the preference parameter is set to true, the verification of the second predetermined criterion is positive for the contact in question. Otherwise, the verification of the second predetermined criterion is negative.

During a step 12, for the contact considered at step 11, display parameters are determined according to the result of the verification carried out at step 11. If the verification is negative, the display parameters for the contact in question are the conventional parameters for displaying a contact on a display interface of the terminal. For example, such parameters correspond to the size of a frame having a size predetermined by the interface, for example a rectangle of N pixels by M pixels or a square of N pixels per side.

If the verification of step 11 is positive, the display parameters for the contact in question are determined so as to enlarge the frame of predetermined size corresponding to the conventional parameters. For example, the display parameters correspond to a rectangle of size 2×N pixels by M pixels. According to this example, the frame in which the pieces of information of the contact will be displayed is twice as high as the frame in which the pieces of information of a contact not fulfilling the second predetermined criterion are displayed. According to another example, the frame can correspond to a square of size 2×N pixels by 2×N pixels.

Steps 10 to 12 can be carried out regularly by the terminal, independently of the fact that the user consults the group of contacts. Otherwise, steps 10 to 12 can be carried out in response to a user interaction step 13 requesting the display of the group of contacts.

Step 13 can correspond to a user interaction on the terminal requesting the opening of the phonebook associated with the terminal. Step 13 can also correspond to a user interaction on the terminal requesting the opening of the call log of the terminal.

When steps 10 to 12 are carried out in response to step 13, the display of the group of contacts is then updated dynamically so that the verification of the second predetermined criterion is implemented from recent measurements when the second predetermined criterion to be verified by a contact corresponds to the frequency of communications between the contact and the terminal.

In response to step 13, at least one subgroup of the group of contacts is displayed during a step 14 on the screen of the terminal according to the arrangement defined in step 10 and according to the display parameters determined during step 12. The number of contacts of the subgroup of the group of contacts displayed during step 14 depends on the display surface on the screen of the terminal, which surface is dedicated to displaying the group of contacts, and on the size of the frames in which the pieces of information relating to each contact are displayed. The display surface is defined by a window displayed by a display interface of the operating system of the terminal.

During step 14, the display interface runs through the contacts of the group of contacts according to the arrangement determined at step 10. For each contact considered during this run-through, the display interface applies the display parameters determined during step 12 for the contact in question in order to display the pieces of information relating to the contact on the screen of the terminal in the display surface.

The pieces of information relating to a contact and displayed on the screen of the terminal are for example illustrated by FIG. 3A according to a particular embodiment. FIG. 3A presents a window displayed on the screen of the terminal and presenting frames 30-34 in which pieces of information relating to a contact are displayed. For example, in the frame 30, respectively 31-34, the name A1, respectively B2, C3, D4 and E5, of the contact in question is displayed at the center of the frame, a photo P1, respectively P2-P5, can be displayed on the left of the frame 30, respectively 31-34, and the date t1, respectively t2-t5, of the last communication is displayed on the right of the frame 30, respectively 31-34.

In FIG. 3A, the contacts C3 and E5 fulfill the second predetermined criterion corresponding for example to the high frequency of communications that the terminal has established with the contacts C3 and E5. In FIG. 3A, the contacts C3 and E5 are emphasized in the list of contacts A1-E5 by the size of the frame in which the pieces of information relating to the contact C3 and E5 are displayed. In FIG. 3A, the frames 32 and 34 are enlarged with respect to the frames 30, 31 and 33 corresponding to the contacts A1, B2 and D4 respectively. The user who consults the list of contacts on his/her terminal can thus better distinguish the contacts C3 and E5 among the list of contacts.

In the particular embodiment described here, an enlarged frame 32 and 34 is displayed in the same window 35 as a standard-sized frame 30, 31 and 33. The user thus has available the list of all his/her contacts on the same window and does not need to navigate between several display windows according to whether or not the contact fulfills the second predetermined criterion.

According to a particular embodiment, an item relating to a communication established with the contact is also displayed in the frame in which the pieces of information relating to the contact are displayed. In FIG. 3A, the frame 31, respectively 32, comprises the start of a message “msg Ib1”, respectively “msg Ic1”, corresponding to the first line of a text message exchanged between the terminal and the contact B2, respectively C3.

According to this particular embodiment, during a step 15 in FIG. 1, for a contact fulfilling the second predetermined criterion, for example the contact C3 in FIG. 3A, at least one additional item, for example “msg I2”, is displayed in the enlarged frame, for example the frame 32 in FIG. 3A. For example, the additional item “msg I2” corresponds to the continuation of the last text message exchanged between the terminal and the contact C3. Thus, for a contact fulfilling the second predetermined criterion, the user can easily have access in its entirety to the last message exchanged with this contact.

FIG. 3B presents a representation of the display of a group of contacts associated with a terminal resulting from the display control method according to another particular embodiment. FIG. 3B takes the same items as FIG. 3A. According to the particular embodiment described by FIG. 3B, the frames 30 to 34 are displayed with a background color that is different according to the age of the last communication established with the contact, for whom the pieces of information are displayed in the frame.

According to this particular embodiment, during step 12 described with reference to FIG. 1, the display parameters also comprise a color to be applied to the frame for the contact in question, for example a background color. The background color is determined according to the age of the last communication established with the contact. For example, for a recent last communication, the background color is dark grey and for an old communication, the background color is light grey. The color can be degraded according to the age. “Recent communication” is understood to mean, for example, a communication established less than two days ago, and “old communication” is understood to mean, for example, a communication established at least a month ago.

FIG. 3B illustrates, for example, that the last communication established with the contact C3, respectively E5, is recent since the background color of the frame in which the pieces of information relating to the contact C3, respectively E5, is dark grey.

According to this particular embodiment, the display control method described with reference to FIG. 1 comprises a step 16 for modifying the color of the frame, in this case the background color of the frame, according to the age of the last communication established with the contact, for whom the pieces of information are displayed in the frame. Modification step 16 can be implemented simultaneously with display step 14 by the display interface.

As a variant, the modified color of the frame can be the color of the outline of the frame or the color of the font of the items displayed in the frame.

According to another variant, the modification of the color of the frame is implemented according to the result of the verification step carried out during step 11. According to this variant, the color of the frame is determined during step 12 according to whether or not the contact in question satisfies the second predetermined criterion. For example, if the contact satisfies the second predetermined criterion, the color of the frame is a dark color, for example dark green. If the contact does not satisfy the second predetermined criterion, the color of the frame is a light color, for example light green.

FIG. 4 presents a representation of the display of a group of contacts associated with a terminal resulting from the display control method described in FIG. 1, according to another particular embodiment.

According to this particular embodiment, the pieces of information relating to a contact are displayed in a square-shaped frame. For example, the frame displays a photo of the contact. The frame 40 corresponds to a contact not fulfilling the second predetermined criterion since the pieces of information relating to this contact are displayed in a frame of standard size. On the other hand, the frame 41 corresponds to a contact fulfilling the second predetermined criterion since the pieces of information relating to this contact are displayed in a frame having a size that is enlarged relative to the standard frame size.

FIG. 2 schematically illustrates a device 20 for controlling the display of a group of contacts associated with a terminal according to a particular embodiment.

The device 20 is suitable for implementing the method for controlling the display of a group of contacts associated with the terminal according to a particular embodiment.

The device 20 comprises a processing module 24, notably comprising a storage module MEM, for example a memory, and a processing unit PROC, equipped for example with a microprocessor. The processing unit PROC is driven by a computer program PG implementing the method for controlling the display of a group of contacts associated with a terminal as described with reference to FIG. 1.

Upon initialization, the code instructions of the computer program PG are for example loaded into the memory MEM before being executed by the processor of the processing unit PROC.

The processor of the processing unit PROC implements the steps of the method for controlling the display of a group of contacts associated with a terminal, according to the instructions of the computer program PG. The processor of the processing unit PROC notably implements:
a step for the arrangement of said group of contacts according to a first predetermined criterion,
for at least one subgroup of the group of contacts, a step for displaying, according to said arrangement, at least one piece of information relating to each contact of the subgroup in a frame of a predetermined size,
when at least one contact of the subgroup fulfills a second predetermined criterion, a step for enlarging the frame in which the piece of information relating to said at least one contact is displayed.

The device 20 also comprises a display device DISP, for example with a screen.

The display on the display device DISP is controlled by a display interface INT. The display interface INT is itself controlled by the processor of the processing unit PROC according to the code instructions of the computer program and of the operating system OS of the device 20.

The device 20 includes a user interaction module IN, for example a numeric keypad or a tactile interface allowing a user to interact on the device 20. The user interaction module IN thus allows the device 20 to detect an interaction of a user requesting the display of a group of contacts associated with the device 20.

The device 20 also includes a communication module COM allowing the device 20 to connect to a communication network and exchange data with terminals connected to this communication network, or to establish communications with other terminals.

According to a particular embodiment, the storage module MEM provides for storing pieces of information relating to the contacts of the group of contacts. The processing module PROC communicates with the storage module MEM in order to supply to the display interface INT the pieces of information relating to the contacts of the group of contacts to be displayed.

According to another particular embodiment, the pieces of information relating to the contacts of the group of contacts are stored on a remote storage medium, for example a server on a communication network (not represented). In this particular embodiment, the device 20 communicates with the server of the communication network in order to obtain the pieces of information relating to the contacts of the group of contacts to be displayed.

According to a particular embodiment, the device 20 is contained in a terminal, such as a mobile terminal, or a fixed terminal, or a tablet.

Although the present disclosure has been described with reference to one or more examples, workers skilled in the art will recognize that changes may be made in form and detail without departing from the scope of the disclosure and/or the appended claims.

1. A method for controlling a display of a group of contacts associated with a terminal, the method comprising the following acts:
arrangement of said group of contacts according to a first predetermined criterion,
for at least one subgroup of the group of contacts, displaying, according to said arrangement, at least one piece of information relating to each contact of the subgroup in a frame of a predetermined size,
when at least one contact of the subgroup fulfills a second predetermined criterion, enlarging the frame in which the piece of information relating to said at least one contact is displayed,
when an item relating to a communication with a contact is also displayed in the frame of predetermined size associated with the contact, for the at least one contact fulfilling the second predetermined criterion, displaying at least one additional item relating to said communication in said enlarged frame.

2. The method according to claim 1, wherein the first predetermined criterion corresponds to an alphabetical order or to a chronological order according to a last communication established between the terminal and a contact considered during the arrangement act.

3. The method according to claim 1, wherein the second predetermined criterion corresponds to the frequency with which the terminal and a contact considered during the arrangement act establish calls.

4. The method according to claim 1, wherein the enlarged frame and a frame of predetermined size are displayed in the same window on a display device of the terminal.

5. The method according to claim 1, wherein, when the frame in which at least one piece of information relating to a contact of the group of contacts is displayed comprises a predetermined color or a predetermined image, the method additionally comprises modifying the color or the image of said frame according to the age of the last communication established with said contact.

6. A device for controlling a display of a group of contacts associated with a terminal, comprising:
a display management module, which is configured to control the display of at least one piece of information relating to each contact of at least one subgroup of the group of contacts, said piece of information being displayed in a frame of predetermined size, said contacts of said subgroup being displayed according to an arrangement of said group of contacts determined according to a first predetermined criterion,
a processing module cooperating with the display management module, the processing module being:
configured to verify whether at least one contact of the subgroup fulfills a second predetermined criterion,
configured to enlarge the size of the frame in which the at least one piece of information relating to said at least one contact is displayed when the at least one contact fulfills the second predetermined criterion,
said display management module further being configured to control:
the display of an item relating to a communication with a contact in the frame of predetermined size associated with said contact, and
for the at least one contact fulfilling the second predetermined criterion, the display of at least one additional item relating to said communication in said enlarged frame.

7. A terminal comprising a display control device according to claim 6.

8. A non-transitory computer readable medium comprising a computer program stored thereon and including program code instructions for controlling a display of a group of contacts associated with a terminal, when the program is executed by a processor, wherein the instructions comprise:
instructions that configure the processor to arrange said group of contacts according to a first predetermined criterion,
instructions that configure the processor to, for at least one subgroup of the group of contacts, display, according to said arrangement, at least one piece of information relating to each contact of the subgroup in a frame of a predetermined size,
instructions that configure the processor to, when at least one contact of the subgroup fulfills a second predetermined criterion, enlarge the frame in which the piece of information relating to said at least one contact is displayed,
instructions that configure the processor to, when an item relating to a communication with a contact is also displayed in the frame of predetermined size associated with the contact, for the at least one contact fulfilling the second predetermined criterion, display at least one additional item relating to said communication in said enlarged frame.
